(19) United States
(12) Patent Application Publication
(10) Pub. No.: US 2005/0216589 A1
(43) Pub. Date: Sep. 29, 2005

(54) System and method for indicating network connectivity and access to an information service offering

(75) Inventors: Philip Ted Kortum, Austin, TX (US); Marc Andrew Sullivan, Austin, TX (US)

Correspondence Address: TOLER & LARSON & ABEL L.L.P., 5000 PLAZA ON THE LAKE STE 265, AUSTIN, TX, 78746, US

(73) Assignee: SBC Knowledge Ventures, L.P.

(21) Appl. No.: 10/811,774

(22) Filed: Mar. 29, 2004

(51) Int. Cl. G06F 15/173

(52) U.S. Cl. 709/225

(57) ABSTRACT

A system and method are disclosed for indicating network connectivity and access to an information service offering. A method incorporating teachings of the present disclosure may include establishing a communication link between a modem of a user and a network aggregation point like a digital subscriber line access multiplexer or a cable head end. The method may also include recognizing or allowing access by the modem to an information service node such as an Internet Service Provider, an electronic mail account, or a Domain Name Server. In some embodiments, the existence of the communication link may be visually indicated at a first location on the modem, and a condition of allowed access to an information service may be visually indicated at a second location on the modem.

### FIELD OF THE INVENTION

The present disclosure relates generally to accessing information networks, and more specifically to a system and method for indicating network connectivity and access to an information service offering.

### BACKGROUND

A network may be characterized by several factors like who can use the network, the type of traffic the network carr ium carrying the traffic, the typical nature of the network's connections, and the transmission ies, the med technology the network uses. For example, one network may be public and carry circuit switched voice traffic while another may be private and carry packet switched data traffic. Whatever the make-up, most networks facilitate the communication of information between at least two nodes, and as such act as communication networks.

At a physical level, a communication network may include a series of nodes interconnected by communication paths. Gaining connectivity to a network and access to the voice and data services available through the network (information service offerings) often represents two distinct steps. When a user's attempt to access an information service offering fails, the user may not know if the failure results from a lack of network connectivity, a lack of authorized access to a service offering, some other problem, and/or a combination of these things. As a result, the user may become frustrated, troubleshooting the problem may be unduly complicated and/or expensive, and the time to cure may be unacceptably long.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 presents a flow diagram for a process that facilitates indicating the connection status of a broadband link in accordance with the teachings of the present disclosure;

FIG. 2 shows one embodiment of a distributed system that incorporates teachings of the present disclosure to indicate the connection status of multiple broadband links; and

FIG. 3 shows one embodiment of a system that incorporates teachings of the present disclosure to indicate the connection status of a subscriber broadband link.

### DETAILED DESCRIPTION OF THE DRAWINGS

Embodiments discussed below describe, in part, indicating to a user both a network connectivity status and a service offering access status. Network connectivity may represent, for example, being communicatively coupled with a network node. And, service offering access may represent, for example, communicating through the network node with a remote computing device using Internet Protocol (IP) communication.

From a high level, a method incorporating teachings of the present disclosure may include establishing a communication link between a user's modem and a network aggregation point like a digital subscriber line access multiplexer (DSLAM) or a cable head end node like a cable modem termination system (CMTS). The method may also include recognizing or allowing access by the modem to an information service node such as an Internet Service Provider (ISP), an electronic mail account server, or a Domain Name Server (DNS). In some embodiments, the existence of the communication link may be visually indicated at a first location on the modem, and a condition of allowed access to an information service may be visually indicated at a second location on the modem. Distinguishing between network connectivity and information service access may allow a user and/or a technician to better troubleshoot a failed attempt to access an information service.

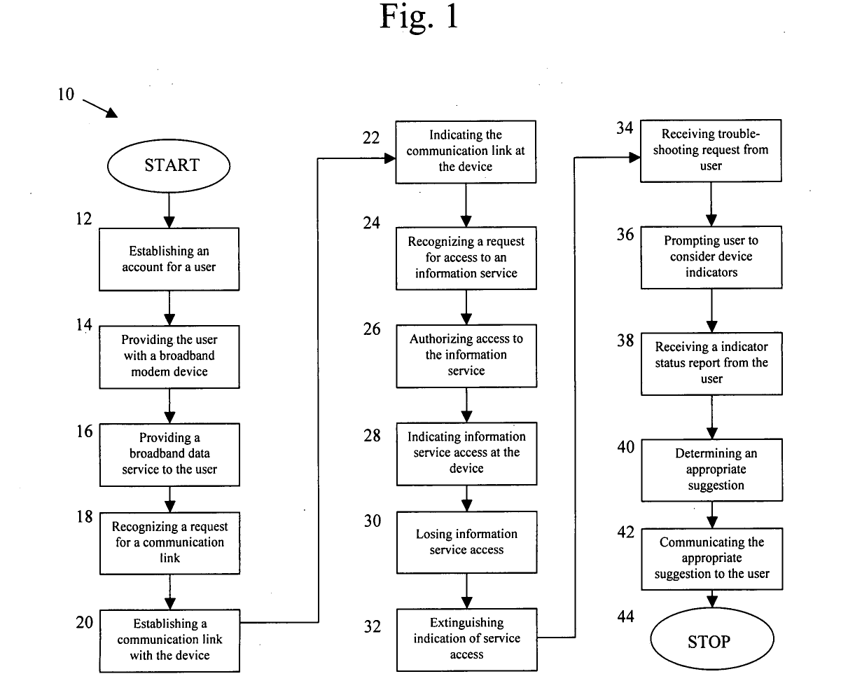

As mentioned above, FIG. 1 presents a flow diagram for a process 10 that facilitates indicating the connection status of a broadband link in accordance with the teachings of the present disclosure. At step 12, a new subscriber may contact a service provider requesting a broadband data service. The service may be a wireline broadband option like Asynchronous Digital Subscriber Line (ADSL), some other form of Digital Subscriber Line technology (xDSL), and/or a cable modem-based offering. The service may also include a fiber-based offering like Fiber to the Home (FTTH) and Passive Optical Networking (PON) and/or a wireless option like fixed wireless, an 802.11x offering, and/or a satellite-based offering.

Whatever the underlying technology and backhaul, the account may be established at step 12. As such, a network operator or service provider may establish the account and define permissions for the user. The account and permissions may “tell” network components to expect communications from the user and how to treat those communications. At step 14, the subscriber may be provided with a modem device. The modem device may have a housing and include a modem module secured within an enclosure formed by the housing. The housing may include a display element or user interface that presents at least one indicator capable of displaying a connectivity status that indicates whether a connection exists between the modem and a network aggregation node. The modem may also include a second indicator capable of displaying a data status that indicates if the modem enjoys access to and intercommunication capabilities with a remote information service node.

At step 16, the user may have “plugged in” the modem device and the service provider may begin providing a broadband data service to the user. At step 18, a network aggregation node may recognize that the modem device is seeking to establish a communication link. The aggregation node may be, for example, a digital subscriber line access multiplexer (DSLAM), some other telephone network node, a cable modem termination system (CMTS), some other piece of cable head end equipment, some other cable network node, and/or some other component capable of supporting communication with the modem device. Whatever its form, the aggregation node may “know” the modem device desires a connection, because the modem device issued a request for connection.

Receiving the request may involve, for example, a combination of network nodes including a Network Access Server (NAS). At step 20, a communication link may be established between the aggregation node and the modem device. In some embodiments, the process may be facilitated by a Point to Point Protocol over Ethernet (PPPoE) client executing at the modem device. In practice, a PPPoE client may be executing on the modem device and/or a computing platform communicatively coupled to the modem device. The PPPoE client may pass a UserID/Password combination to a network access server (NAS), which may utilize a security server, such as a RADIUS server, to authenticate the user and authorize the requested access.

In some embodiments, authentication and authorization may be performed in a single step. When a user logs on to the network, a NAS may prompt the user for their user name and password. The NAS may then send the request to the security server. Depending on implementation detail, the NAS may include with the request a proposed configuration and/or some additional set of attributes for the user. The NAS may propose, for example, that the user be assigned a certain Internet Protocol (IP) address and subnet mask. The NAS request may also include information about the user's caller ID, the port the user is using, and/or some other attributes. In some embodiments, much of this process may occur in a near transparent way. A system and method for facilitating near transparent log-ins is described in pending U.S. application Ser. No. ______, which is expressly incorporated herein by reference.

Based on the information in the request, the security server may return a response to the NAS, which may include a permit response, a deny response, or some other appropriate response. In the case of a permit response, the security server may also tell the NAS to apply other attributes to the user. For example, the security server may tell the NAS to use a different IP address, or to apply certain access filters or timeout values to the user.

In response to establishing a communication link with an aggregation node, a system incorporating teachings of the present disclosure may, at step 22, provide an indication to the user of a viable connection. The indication may, for example, be a visual indication presented within a user interface of the modem device. For example, a specific light emitting diode (LED) may be lighted or a “good connection” icon may be displayed.

At step 24, a user's desire to access an information service node may be recognized. Perhaps the user desires Public Internet access and seeks to communicate with an Internet Service Provider (ISP), an electronic mail account server, or a Domain Name Server (DNS), which may entail the use of Internet Protocol (IP) communication. At step 26, access to the information service node may be authorized. For example, it may be determined that the modem device and the information service node are capable of sending signals to one another and “know” how to intercommunicate.

At step 28, an indication of access may be provided to the user. As with the communication link indicator, the access indicator may be a visual indication presented within a user interface of the modem device. Again, a specific light emitting diode (LED) may be lighted or a “data access” icon may be displayed.

At step 30, a loss of access to the information service node may be recognized. Perhaps, the DNS server or some ISP node has gone down. At step 32, the indication of “data access” may be extinguished to allow the user to know that access has been lost. To the user, loss of “data access” may manifest itself in several different ways. For example, the user may be browsing various websites. As the user tries to link to a new site, the user may be presented with an error message explaining that the page is unavailable. Frustrated, the user may begin trying to resolve the problem. If this fails, the user may call a help desk of the service provider.

At step 34, a trouble shooting request may be received by the service provider. In response, a service professional may instruct the user at step 36 to look at the visual indicators on the modem device. At step 38, the user may report back to the service professional that the “good connection” indicator is visible but that the “data access” indicator is not. This combination of indicators may allow the service professional to determine that the physical connection to the aggregation node is fine and, as such, focus any remediation efforts on data access components. At step 40, the service professional may determine an appropriate suggestion and at step 42 the suggestion may be communicated to the user. Process 10 may then progress to stop at step 44. Individual steps of process 10 may be amended, re-ordered, added, and/or deleted without departing from the teachings. In addition, the party or device performing various steps may be altered as well to make effective use of available resources within a system implementing some or all of process 10.

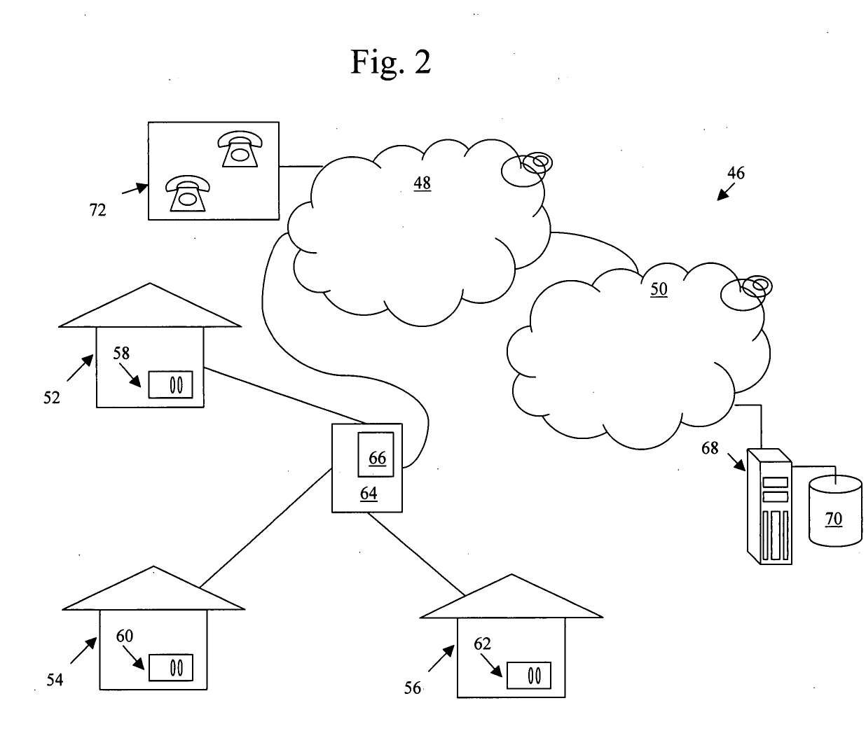

As mentioned above, FIG. 2 shows one embodiment of a distributed system 46 that incorporates teachings of the present disclosure to indicate the connection status of multiple broadband links. In operation, end users may seek access through a service provider network 48 to an information network 50, like the Public Internet, an Intranet, an Extranet, some other communication network, and/or some combination thereof. As shown, system 46 includes several premises 52, 54, and 56, each having its own broadband modem 58, 60, and 62, respectively.

In practice, a laptop computer in premises 52 may have a broadband backhaul via modem 58. The modem may be capable of communicatively coupling to service provider network 48. Network 48 may include, for example, a Public Switched Telephone Network (PSTN), a cable network, some xDSL infrastructure, a wireless network, and/or some other networking components capable of facilitating data communication. Whatever its make up, network 48 may be capable of communicating information. The communication could occur, for example, across dedicated circuits, as IP packets, and/or across an air interface.

As depicted, modem 58 may communicate with and/or through a facility 64 of network 48. Facility 64 may be, for example, a remote terminal (RT) site, a central office, a cable head end, or some other provider facility. As such, facility 64 may include network nodes like aggregation point 66, which may be a DSLAM or a CMTS for example. In operation, a user may connect to aggregation point 66 and seek access to an information services server like unified messaging server 68, which may have an associated repository 70 maintaining email, voice mail, facsimile, and other messages for the user living at premises 52.

Occasionally, the user may not be able to access server 68. In response, the user may contact an outsourced call center 72 and request assistance. In an embodiment in which modem 58 includes both a connection LED and a data LED, call center personnel may be able to isolate and identify the user's problem. If the connection LED is extinguished, the call center operator may determine that the problem is with the physical connection between modem 58 and aggregation point 66. If the connection LED is lighted and the data LED is extinguished, the call center operator may determine that the problem is an IP problem. Perhaps the DNS or the ISP is down. By isolating and identifying the problem, the call center operator may be able to more quickly resolve the user's problem. The call center operator may no longer need to work through all the possible fixes—the operator may instead focus on what appears to be broken.

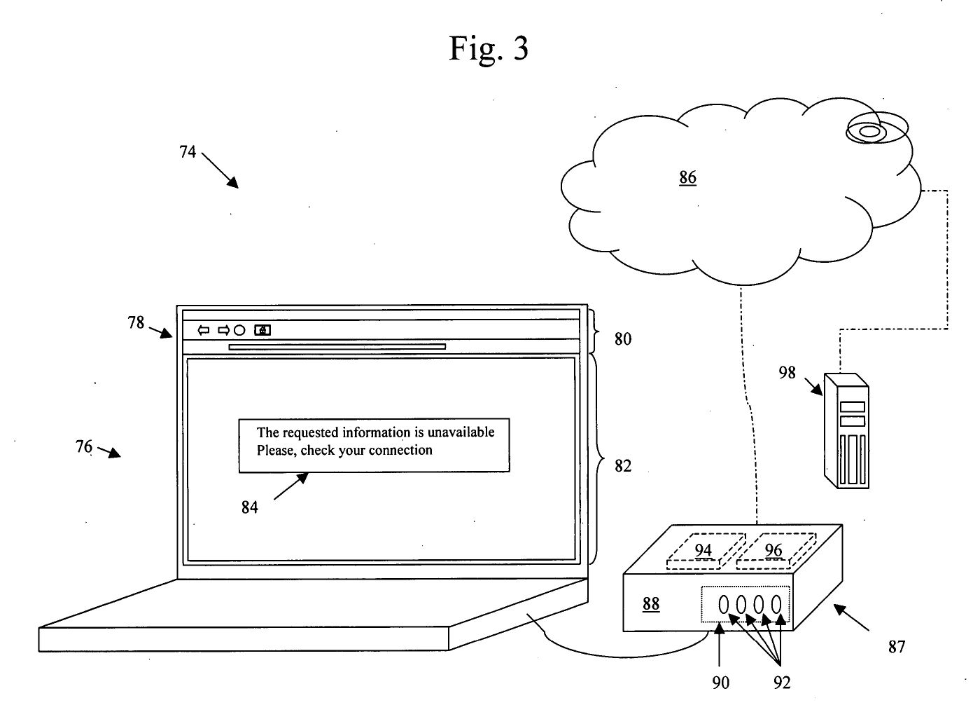

As mentioned above, FIG. 3 shows one embodiment of a system 74 that incorporates teachings of the present disclosure to indicate the connection status of a subscriber broadband link. As shown, system 74 may include a computer 76 having a display device 78. When a user begins a browsing session, the user may launch a web browser application like Internet Explorer™, which may cause the presentation of a browser bar 80 and a document pane 82 on display 78.

As shown, document pane 82 includes a GUI element 84 informing the user that a requested page is unavailable. The user may not know, at this point, why the page is unavailable. It may be that computer 76 is not properly connected to a node of provider network 86. In the depicted embodiment, computer 76 relies on modem 87 to facilitate connection to network 86.

As shown, modem 87 includes a housing component 88 and a user interface 90 coupled thereto. User interface 90 includes a collection of visual display portions 92. Display portions 92 may be embodied as individual LEDs, indicators, locations on a screen display, and/or some other embodiment capable of communicating some status information to a user. In preferred embodiments, display portions 92 may include a label of some sort. For example, words like “POWER”, “DATA”, “LINK”, and/or “ON”, may be presented near respective indicators of display portions 92 to let a user know the relevance of the information conveyed via display portions 92.

As shown, housing component 88 may at least partially define an enclosure housing a broadband modem module 94 and a processor 96. Processor 96 may be communicatively coupled to module 94 and may embody a link detection mechanism capable of outputting a link signal in response to a determination that a communication link exists between broadband modem module 94 and a network aggregation point of network 86. Processor 96 may also embody a data detection mechanism capable of outputting an access signal in response to a recognition that broadband modem module 94 enjoys access to a remote information service node like server 98.

In operation, a first one of the display portions 92 may display an active link indicator within user interface 90 in response to the link signal output by processor 96. Similarly, a second one of the display portions 92 may display a data service access indicator within user interface 90 in response to the access signal output by processor 96. Processor 96 may also perform and/or embody other functions for modem 87. For example, processor 96 may execute computer readable instructions directing processor 96 to execute a PPPoE client, to perform some level of diagnostics, to manage IP address conditions, to communicate status information to computer 76, to manage intercommunication of information with computer 76, and/or other functions.

As mentioned above, communication between modem 87 and a node of network 86 may take several forms. Communication may occur across dedicated circuits, in a packetized manner, across virtual connections, in a special data frequency band, across a wireline connection including copper, optical fiber, coaxial fiber, an air interface, and/or a combination thereof. Similarly, communication between modem 87 and computer 76 may take several forms. There may be a physical link of copper, coax, fiber, etc. There may also be an air interface that utilizes Radio Frequency (RF) communication. As such, a device like computer 76 and modem 87 may be capable of Radio Frequency communication with one another and with other nodes via a Wireless LAN using a short-range or local wireless technology like 802.11, Wi-Fi, Bluetooth, and/or some other technique.

It should be understood that the mechanisms, computers, devices, engines, servers, and/or platforms, described herein, may take several different forms and may be stand alone and/or incorporated into several different pieces of equipment, like laptop computers, desktop computers, telephones, mainframes, PSTN switches, Ethernet switches, routers, gateways, hardware, firmware, software, work stations, other options having some level of computing capability, and/or a combination thereof. For example, various engines could be independent applications, could be independent servers, could be executing on different platforms, and/or could be executing on a single platform.

The methods and systems described herein provide for an adaptable implementation. Although certain embodiments have been described using specific examples, it will be apparent to those skilled in the art that the invention is not limited to these few examples. Note also, that although certain illustrative embodiments have been shown and described in detail herein, along with certain variants thereof, many other varied embodiments may be constructed by those skilled in the art.

The benefits, advantages, solutions to problems, and any element(s) that may cause any benefit, advantage, or solution to occur or become more pronounced are not to be construed as a critical, required, or essential feature or element of the present invention. Accordingly, the present invention is not intended to be limited to the specific form set forth herein, but on the contrary, it is intended to cover such alternatives, modifications, and equivalents, as can be reasonably included within the spirit and scope of the invention as provided by the claims below.

1. A method of indicating connectivity comprising:
establishing a communication link between a modem of a user and a network aggregation point;
authorizing access by the modem to an information service;
visually indicating an existence of the communication link at a first location of the modem; and
visually indicating an availability of the information service at a second location of the modem.

2. The method of claim 1, further comprising:
utilizing a first light emitting diode to indicate the existence of the communication link; and
utilizing a second light emitting diode to indicate the availability of the information service.

3. The method of claim 1, executing a Point to Point Protocol over Ethernet client in connection with establishing the communication link.

4. The method of claim 1, communicating a user credential to an authentication server in connection with authorizing access to the information service.

5. The method of claim 1, further comprising communicating information from the information service to the modem via the network aggregation point.

6. The method of claim 1, wherein the modem comprises a user interface having visual display capabilities.

7. The method of claim 6, wherein the user interface comprises the first location and the second location.

8. The method of claim 1, further comprising distributing the modem to the user.

9. The method of claim 1, wherein the modem comprises an xDSL modem.

10. The method of claim 1, wherein the modem comprises a cable modem.

11. The method of claim 1, wherein the network aggregation point comprises a cable modem termination system.

12. The method of claim 1, wherein the network aggregation point comprises a digital subscriber line access multiplexer.

13. The method of claim 1, further comprising disabling an indication of the existence of the communication link in response to recognizing a loss of the communication link.

14. A connectivity indication system, comprising:
a user interface coupled to a housing component, the user interface comprising a visual display portion;
the housing component at least partially defining an enclosure;
a broadband modem module secured within the enclosure;
a link detection mechanism communicatively coupled to the broadband modem module and operable to output a link signal in response to a determination that a communication link exists between the broadband modem module and a network aggregation point;
a data detection mechanism operable to output an access signal in response to a recognition that the broadband modem module enjoys access to a remote information service;
a first indicator operable to be displayed within the user interface in response to the link signal; and
a second indicator operable to be displayed within the user interface in response to the access signal.

15. The system of claim 14, wherein the user interface comprises a plurality of light emitting diodes within the visual display portion, further wherein the first indicator comprises a lighted one of the plurality of light emitting diodes and the second indicator comprises a different lighted one of the plurality of light emitting diodes.

16. The system of claim 14, wherein the broadband modem module comprises a cable modem.

17. The system of claim 14, wherein the broadband modem module comprises an xDSL modem.

18. The system of claim 14, further comprising a PPPoE client executing on a processor secured within the enclosure.

19. A method of generating connectivity awareness comprising:
providing a subscriber with a broadband modem comprising at least a first indicator operable to display a connectivity status indicating whether a connection exists between the broadband modem and a network aggregation node and a second indicator operable to display a data status indicating an availability of access to a remote information service node; and
providing a broadband data service to the subscriber.

20. The method of claim 19, further comprising:
receiving a trouble shooting request from the subscriber, the trouble shooting request relating to the broadband service; and
prompting the user to observe the first and second indicator.

21. The method of claim 20, further comprising:
receiving a communication indicating that the first indicator displays a positive connectivity status and the second indicator displays a negative data status; and
determining an appropriate suggestion responsive to the trouble shooting request.
